(19) United States
(12) Patent Application Publication
(10) Pub. No.: US 2011/0259377 A1
(43) Pub. Date: Oct. 27, 2011

(54) PORTABLE VEHICLE UNDERCARRIAGE WASHING DEVICE

(76) Inventor: Gregory Butler, Arlington, VA (US)

(21) Appl. No.: 12/765,107

(22) Filed: Apr. 22, 2010

(51) Int. Cl. B08B 3/00

(52) U.S. Cl. 134/123

(57) ABSTRACT

A portable, storable undercarriage cleaning device is disclosed. The cleaning device two ramps, a restriction bar, and perforated fluid conduit. A first ramp and second ramp include a fluid channel transversely spanning the interiors. A hose may be connected to the first ramp, which connects to the fluid conduit that spans the fluid channels of the ramps as they are spaced apart. The restriction bar maintains the spacing of the ramps during use.

### FIELD OF THE INVENTION

The present invention relates to the field of vehicle accessories and more specifically to the field of vehicle cleaning devices.

### BACKGROUND

Motor vehicles have revolutionized travel. They have the ability to transport goods and users over great distances in various types of weather. Inclement weather, in particular, presents a long-term hazard to motor vehicles. Tires that contact wet roads spray water contaminated with road particles onto the undercarriage of vehicles. Tires that contact roads salted for traction during and after heavy snowfalls splatter salt particles onto the undercarriage of vehicles. In addition to dirtying the undercarriage of the vehicle, foreign particles may corrode or degrade the structure or operability of the vehicle.

Presently, the preferred means of cleaning a vehicle undercarriage includes professional cleaning at a large carwash facility having liquid jets underneath a predetermined track for a vehicle. The equipment used by carwash facilities is large and costly. Previous attempts to provide means for consumers to clean a vehicle undercarriage have resulted in various devices with disadvantages. References that attempt to address consumer equipment for undercarriage cleaning can be sorted into two general classes. The first class includes carriages and is typified by U.S. Pat. No. 6,247,658. The '658 patent discloses a wheeled carriage a jet nozzle that is pushed under a vehicle like a vacuum cleaner. The carriage variety of solutions present a cost-effective cleaner, but the limited stream from the nozzle requires a highly-regimented cleaning in order to attain uniform cleaning of a surface that the user cannot view. Furthermore, it assumes that the vehicle undercarriage is above the ground to a degree that permits a carriage to pass thereunder, and that a user has an arm range and strength that permits usage of the carriage.

The second class of solutions includes ramps that attempt small-scale emulation of the large-scale industrial equipment and is typified by U.S. Pat. No. 3,342,191. The '191 patent discloses a relatively large structure with ramps and a fluid conduit that runs transversely under the path of vehicle. This structure is large, rigid, and not suitable for efficient use by a consumer. Therefore, there is a need for a storable and portable undercarriage washing device that is cost-effective and capable of effective cleaning.

### SUMMARY

The present invention is directed to a portable vehicle undercarriage washing device. The device includes a first ramp, second ramp, restriction bar, and fluid conduit. The first ramp and second ramp both include a width, an inlet sidewall, an outlet sidewall, and a fluid channel transversely spanning the interior. The first ramp includes an inlet port on the first ramp's inlet sidewall positioned over the first ramp's fluid channel. The inlet port includes an inlet port primary aperture for receiving a hose end.

A perforated fluid conduit is affixed to the first ramp, preferably either to the outlet sidewall and flush with the first ramp's fluid channel or within the fluid channel directly to the inlet port. The fluid conduit lays on a surface unnaffixed from the first ramp's outlet sidewall through and beyond the second ramp's fluid channel. The fluid contact is in fluid communication with the inlet port primary aperture of the port inlet. The fluid conduit is pliable and flexible to the degree that the fluid conduit may be wrapped upon itself. The fluid conduit and second ramp's fluid channel form a close-fit relation that permits the second fluid channel to statically maintain a predetermined orientation of the fluid conduit contained therein. However, the close fit relationship permits the fluid conduit to slide freely through the fluid channel of the second ramp.

The restriction bar contacts the first ramp and the second ramp and positions the first ramp and the second ramp at a space determined by a user. The restriction bar is size-adjustable to account for the differing wheel bases of multiple vehicles. The first and second ramps further include a mating fastening complex, which when the first ramp is positioned adjacent to the second ramp in a storage position maintains the storage position. A fluid conduit restriction member, which may include a valve on the fluid conduit or outcropping on the second ramp, terminates or diminishes the flow of the fluid within the fluid conduit past the restriction member.

Therefore, it is an aspect of the present invention to provide a portable means of cleaning an undercarriage.

It is a further aspect of the present invention to provide a means of cleaning an undercarriage using cleaning additives.

It is a further aspect of the present invention to provide a means of cleaning an undercarriage that applies to a wide variety of vehicle sizes.

It is a further aspect of the present invention to provide a means of cleaning an undercarriage that is conveniently stored, removed, set-up, and applied.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a plan view of the undercarriage cleaning device.

FIG. 2 is a perspective, partial view of the undercarriage cleaning device.

FIG. 3 is a perspective, partial view of the undercarriage cleaning device.

FIG. 4 is a perspective, partial view of the undercarriage cleaning device.

FIG. 5 is a perspective, partial view of the undercarriage cleaning device.

FIG. 6 is a perspective view of restriction bars of the undercarriage cleaning device.

### DETAILED DESCRIPTION

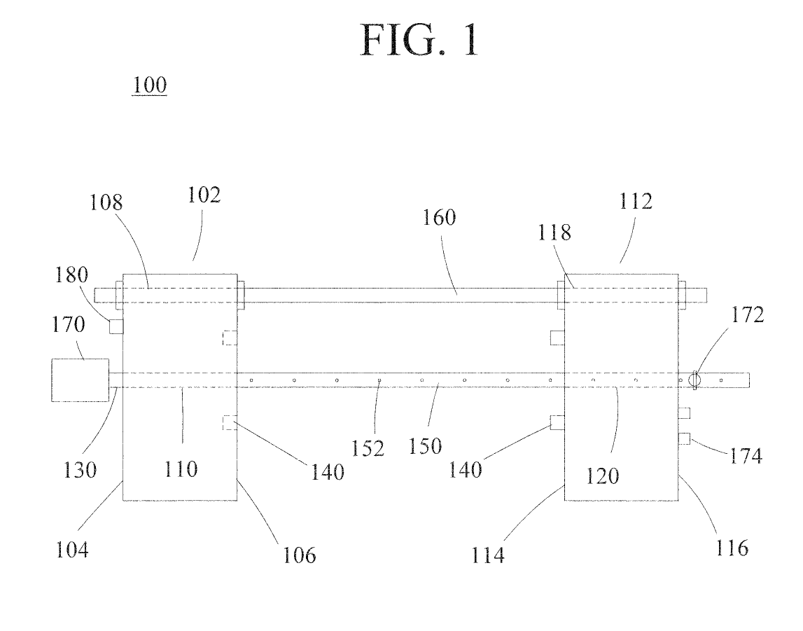

Referring first to FIG. 1, a basic embodiment of the undercarriage cleaning device 100 is shown. The undercarriage cleaning device 100 includes a first ramp 102, second ramp 112, restriction bar 160, and fluid conduit 150. The first ramp 102 and the second ramp 112 may be freely adjusted in span along both the restriction bar 160 and the fluid conduit 150. The fluid conduit 150 slides through the interior of the second ramp 112 during adjustment and the restriction bar may either be removed during the adjustment and repositioned upon reaching a predetermined spacing, or the restriction bar may adjust with the first ramp and second ramp during adjustment. Thus the central members of the device 100, i.e. the restriction bar and the fluid conduit, do not substantially interfere with the compact storage or adjustment of the present invention.

Turning now to FIG. 2, the first ramp 102 dimensions of note include a width, w₁, an inlet sidewall 104, and an outlet sidewall 106. The first ramp includes a variable height in the nature of ramps in general. The body of the first ramp 102 defines a first fluid channel 110 that spans the width of the first ramp transversely. An inlet port 130 is positioned on the first ramp inlet sidewall 104 directly adjacent to the first fluid channel 110. It is preferred that the first fluid channel be positioned and sized such that any opening leading from the port 130 to the first fluid channel 110 is positioned in a flush manner. The port 130 may protrude from the first ramp 102, or the port 130 may be positioned within the first ramp such that the first fluid channel and the port are indistinguishable. The preferred port includes a primary inlet aperture 132 for receiving a hose end and a secondary inlet aperture 134 for receiving a secondary liquid container 136.

The secondary liquid container 136 is a container having a closed interior, i.e. the interior is not fluidly connected to an infinite fluid source, such as a hose. The secondary container 136 may be filled with a cleaning solution or other fluid that may be advantageously combined with water for contact with a vehicle undercarriage. The fluid from the secondary container travels through the secondary inlet aperture into the fluid port for regulated dispersal via a dispensing unit (not shown). When the secondary container is not in use, a cap (not shown) adapted to fit upon the secondary inlet may be utilized to prevent the egress of fluid from the primary inlet or a one-way valve may be utilized within the port. Water under pressure passes from the primary inlet into interior passages within the body of the port, to which the secondary inlet is upwardly connected. Variably predetermined interior passage diameters within the port are utilized to pressurize the secondary liquid container. The flow of fluid from the primary inlet creates a circulation within the secondary fluid container which mixes the fluid within the secondary container with the fluid from the primary inlet. The mixture is gradually discharged from the bottle through the passage of a smaller diameter downwardly through the inlet and back into the inlet port body. The secondary liquid container is removable from the secondary inlet, and preferably each includes mating threaded connections.

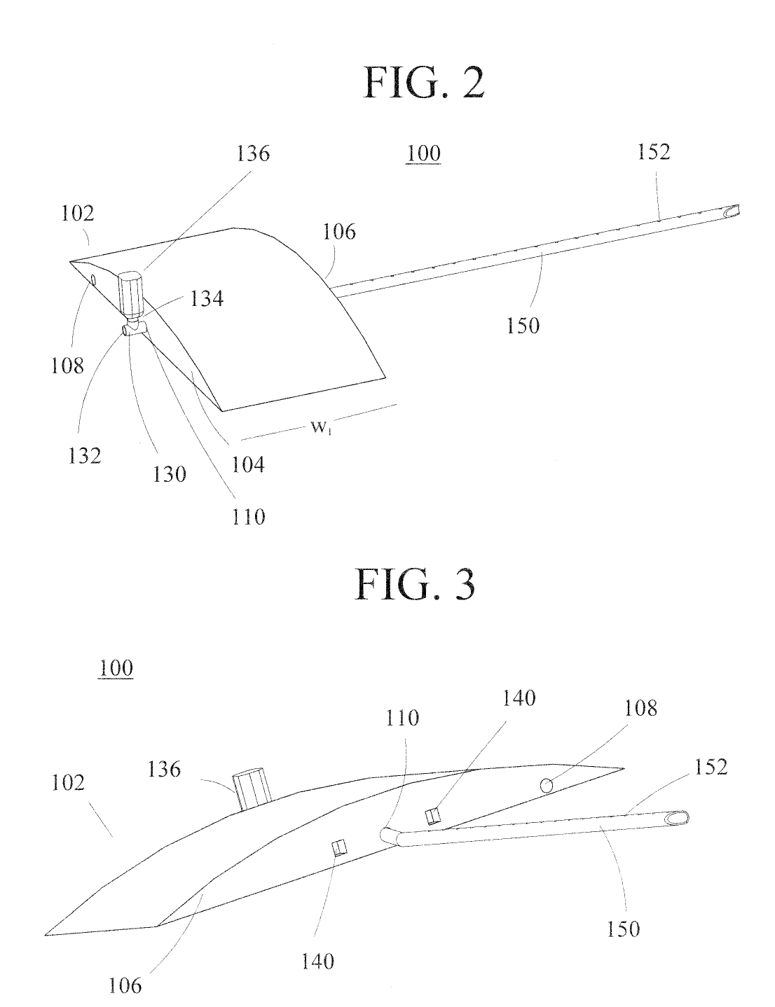

Turning now to FIGS. 2 and 3, a fluid conduit 150 accepts fluid derived from the inlet port 130. The fluid conduit 150 may accept the fluid directly from the inlet port 130 or the fluid conduit may accept the fluid from the inlet port 130 by way of the first channel 110. The present invention may be configured such that the interior of the first ramp acts as an intermediate conduit with the fluid conduit 150 being merely attached to the outlet sidewall 106 of the first ramp 102 or only partially within the first channel 110. The fluid conduit 150 is a strong pipe that is pliable and includes perforations 152. The fluid conduit 150 includes a strong, yet deformable, outer wall capable of accepting the weight of an automobile without damage to the fluid conduit 150. The pliable nature of the fluid conduit permits the outer wall deformation in response to automobile weight, and also permits the fluid conduit to be wrapped upon itself and the device 100. The perforations 152 within the wall of the fluid conduit 150 are preferably positioned along a single orientation of the fluid conduit. The spacing of the perforations may be any as desired by users or manufacturers. Although the fluid conduit 150 is affixed to the first ramp, the fluid conduit extends unaffixed through the second ramp (not shown)

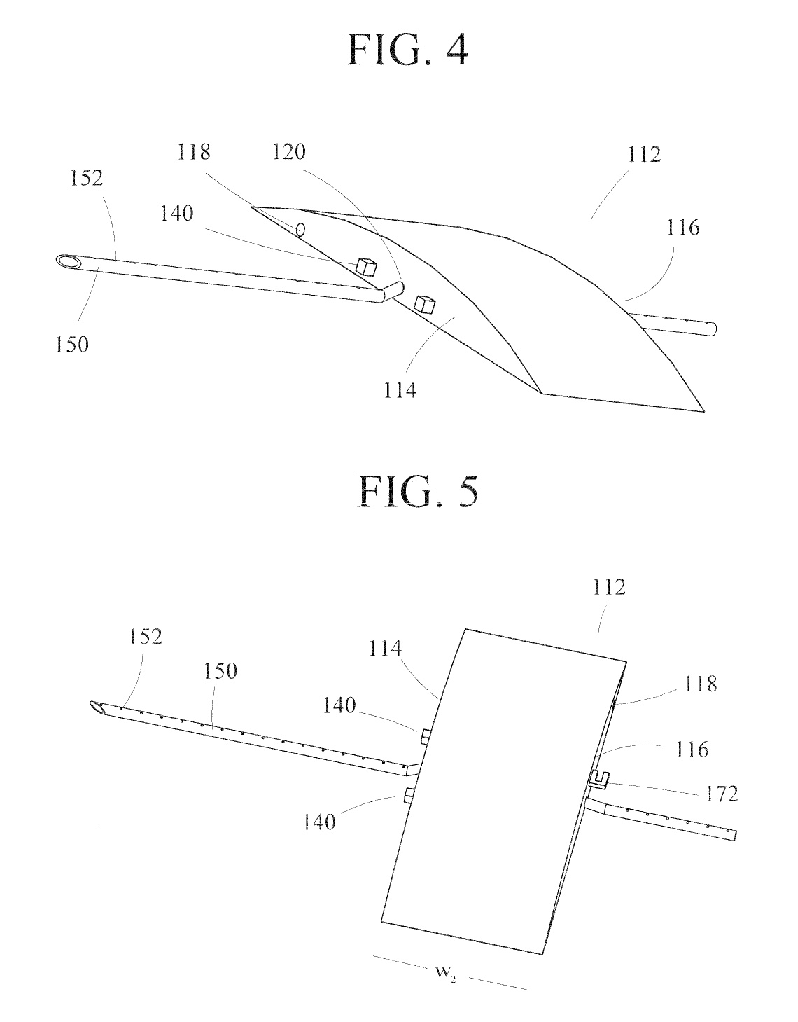

Turning now to FIGS. 4 and 5, the fluid conduit 150 extends through the second ramp 112 without any permanent attachment. By permanent attachment, it is meant attachment that occurs during the manufacturing or later assembly process that is meant to be removable until through breakage. The fluid conduit 150 extends through a second channel 120 within the second ramp 112. The second channel 120 transversely spans the entirety of the second ramp width w2 from the second ramp inlet sidewall 114 to the second ramp outlet sidewall 116. The second channel 120 preferable includes dimensions that permit the fluid conduit 150 to freely pass therethrough such that a user may without difficulty longitudinally pull or push the fluid conduit 150 through the second channel 120. However, the second channel dimensions should also be such that a close-fit relationship is formed with the fluid conduit. The close fit relationship permits the fluid conduit to be closely positioned such that the interior of the second channel negates or retards the ability of the fluid channel to rotate radially. Thus, a user can determine an orientation of the fluid conduit, which may be directly upwards facing or slanted to one side or other, and can rely upon the weight of the fluid conduit and second channel dimensions to steady the orientation of the fluid conduit. The second ramp 112 should have dimensions equivalent to those of the first ramp 102.

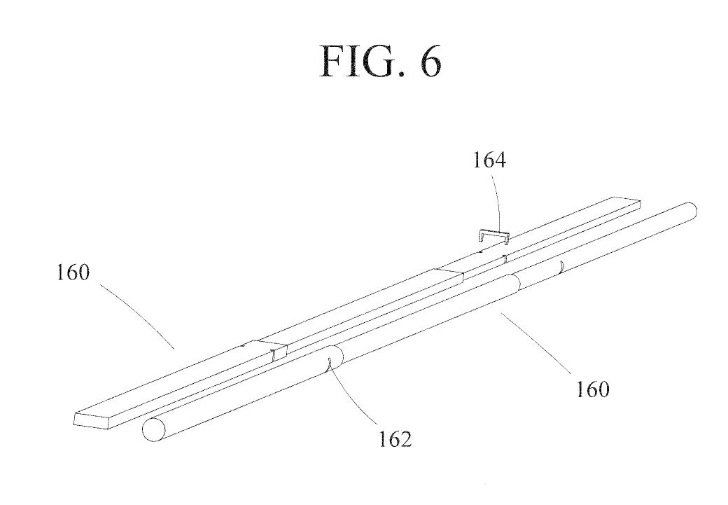

Turning now to FIGS. 1 and 6, a restriction bar 160 spans the distance of a vehicle wheelbase between the first ramp 102 and the second ramp 112. The restriction bar 160 prevent the ramps from moving independently. The preferred restriction bar 160 includes substantially flat dimensions. Such dimensions guard against horizontal torsion while allowing vertical flexibility for uneven surfaces. The restriction bar 160 passes through a first restriction bar channel 108 in the first ramp 102 and through a second restriction bar channel 118 in the second ramp 112. The restriction bar channels 108, 118, when utilized, should closely match the dimensions of the restriction bar 160. The preferred restriction bar 160 includes a telescoping body, peripherally-positioned ridges 162, and restrictor clips 164. The restrictor clips 164 removably affix to the restriction bar 160 have a body dimensioned, upon adjacent placement to a ramp, to form a barrier to the lateral motion of the ramps. The peripheral ridges 162 may include a single set of indentations, two sets of indentations, or more than two sets of indentations. A single set of indentations prevents lateral motion in a single direction, preferably prepositioned according to a single standard wheelbase. Two sets of indentations prevent lateral motion in both directions, preferably prepositioned according to a single standard wheelbase. Three or more sets of indentations allows the motion restriction benefits of two indentation sets, but also permits more variable positioning of the restrictor clips that may be unrelated to a single wheelbase standard. Alternatively, the body of the ramps 102, 112 may include apertures or projections to position the restrictor bar such between the first ramp outlet sidewall 106 and the second ramp inlet sidewall 114. A preferred structuring includes a first restrictor bar channel 108 and a second restrictor bar channel 118 that only partially penetrates the first ramp 102 and second ramp 112, respectively. Thus, the restriction bar ends contact the ramp interiors as a buttress against inward lateral movement of the ramps. Depressible protrusions within the restrictor bar 160 may be included thereon that match with mating interior portions of the ramp restrictor bar channels for preventing outward and inward lateral movement of the ramps.

The restriction bar 160 when collapsed for storage may be positioned on the any sidewall of any ramp by a restrictor bar holder 180. The preferred restrictor bar holder 180 forms an interference fit with the restriction bar 160 to maintain the restrictor bar upon a ramp. The restrictor bar holder may include any means of retaining an elongate object upon a sidewall or within the body of the ramp, e.g. within the first restriction bar channel 108 or the second restriction bar channel 118.

A fastening complex 140 may be positioned on the second ramp 112 and the first ramp 102. The fastening complex 140 of each ramp is configured to mate, one with the other. A preferred mating complex includes protrusions and apertures positioned on the second ramp inlet sidewall 114 and/or the first ramp outlet sidewall 106. The mating complex forms a close fit relationship or interference fit relationship that prevents substantial, undesired motion during storage of the device 100. The device 100 may be collapsed for storage by laterally moving the second ramp 112 towards the first ramp 102. As the fluid conduit 150 is not permanently affixed to the second ramp 112, the fluid conduit acts as a track for the lateral movement and affixation through the fastening complex 140. In a like manner, the device may be adjusted to accommodate multiple vehicle wheelbase, and multiple vehicle types.

A conduit restriction member 172 acts to restrict the flow of fluid through the fluid conduit 150. The fluid conduit 150 includes a closed end, but the fluid conduit may include perforations 152 beyond a length needed to effectively clean a vehicle undercarriage. To ensure the effective use of fluid through the fluid conduit a conduit restriction member includes any means capable of collapsing the pliable fluid conduit 150 outer wall. Among the many options, two are preferred. In a first preferred conduit restriction member, as shown in FIG. 1, the device 100 includes a slidable restriction valve that upon actuation of a handle, a base is pushed into the body of the fluid conduit 150. The inward motion of the base collapses the fluid conduit outer wall into a position where little or no fluid may pass farther. To accommodate the multiple adjustments possible with the fluid conduit, the valve slides longitudinally along the body of the fluid conduit. A second preferred conduit restriction member, as shown in FIG. 5, the second ramp 112 includes an outlet sidewall 116 that holds the conduit restriction member 172. The conduit restriction member includes protrusions that form void that accepts the fluid conduit. The user pulls the fluid conduit adjacent to conduit restriction member, and when the fluid conduit has been pulled tautly, the user then positions the fluid conduit member within the interior void of the conduit restriction member. The interior void of the conduit restriction member is sized such that the conduit restriction member body collapses the outer wall of the fluid conduit.

Returning to FIG. 1, to permit the effective storage of the device 100, a ramp 102, 112 includes conduit brackets 174 to permit the fluid conduit 150 to be wrapped around both the first ramp 102 and second ramp 112. The conduit brackets 174 maintain the position of the wrapped fluid conduit. To further enhance the present invention, ancillary devices may be utilized. As an example, a fluid pressurizer 170 may be placed in fluid communication with the inlet port 130.

In use of the preferred device 100, a user will place the ramps in front of vehicle tires and adjust width appropriately. The user will then adjust the restriction bar and pass through the ramps. The user then affixes tensioned restrictor clips onto the restriction bar. The restrictor clips stay in place by sitting in the peripheral ridges of the restriction bar. The fluid conduit is then pulled taut from the outlet wall of the second ramp and then the fluid conduit is restricted beyond usable portions thereof. The user then turns on the water supply from outdoor spigot. The user may then drive a vehicle forward and backward over the device for desired cleaning duration.

To store the preferred device 100, a user turns off the water supply. The user releases the fluid conduit from the restriction of the restriction conduit. The user then removes the restrictor clips and slides the restriction bar from both ramps. The restriction bar is then collapsed and the ramps are then slid one upon the other. The user then unscrews a garden hose from the first ramp and optional pressure washer and optionally the secondary fluid container. The fluid conduit is wrapped around both ramps, locked into place, and then the restriction bar is affixed to a ramp.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A portable vehicle undercarriage washing device comprising:
a first ramp with a width, an inlet sidewall, and an outlet sidewall opposite said inlet first ramp inlet sidewall, said first ramp having a variable height and defining a first fluid channel transversely spanning said first ramp width;
an inlet port, statically positioned on said first ramp inlet sidewall directly adjacent to said first fluid channel, with a primary inlet aperture adapted to receive a hose end;
a second ramp with a width and an inlet sidewall, and an outlet sidewall opposite said first ramp inlet sidewall, said second ramp having a variable height and defining a second fluid channel transversely spanning said second ramp width;
a perforated, pliable fluid conduit, affixed to said first ramp and extending unnaffixed from said first ramp outlet sidewall through second fluid channel from said second ramp inlet sidewall to and beyond said second ramp outlet sidewall, in fluid communication with said inlet port, wherein said fluid conduit is flexible to permit wrapping of said fluid conduit upon itself, and wherein said fluid conduit and said second fluid channel form a close-fit relation that permits said second fluid channel to statically maintain an predetermined orientation of said fluid conduit;
a restriction bar, removably spanning a wheelbase distance between said first ramp and said second ramp, contacting both said first ramp and second ramp to promote a stationary positioning on a substantially planar surface, wherein said restriction bar is size adjustable to permit user-determinable, parallel spacing of said first ramp to said second ramp;
a mating fastening complex positioned on said first ramp outlet sidewall and said second ramp inlet sidewall; and
a conduit restriction member, positioned on at least one of said second ramp and said fluid conduit, adapted to restrict fluid flow through said fluid conduit.

2. The device of claim 1 further comprising a secondary inlet aperture in fluid communication with said inlet port.

3. The device of claim 2 wherein said inlet port protrudes from said first ramp and includes an interior dispensing unit for the regulated passage of fluid from said secondary inlet aperture.

4. The device of claim 3 further comprising a secondary liquid container, removably affixed to said secondary inlet aperture, and wherein said secondary inlet aperture is positioned on said inlet port.

5. The device of claim 1 wherein said restriction bar includes a telescoping body.

6. The device of claim 5 further comprising restrictor clips, adapted to removable adhere via pressure mount to said restrictor bar, and wherein said restriction bar includes a substantially flat profile.

7. The device of claim 6 wherein said restrictor bar includes peripheral clip notches adapted to position said restrictor clips thereon.

8. The device of claim 1 further comprising a restrainer, positioned on said second ramp, dimensioned to retain and collapse said fluid conduit.

9. The device of claim 1 further comprising wind clips, protruding from both said first ramp inlet sidewall and said second ramp outlet sidewall.

10. The device of claim wherein said first ramp defines a first restrictor bar channel transversely spanning said first ramp width, and said second ramp defines a second restrictor bar channel transversely spanning said second ramp width.

11. A portable vehicle undercarriage washing device comprising:
a first ramp with a width, an inlet sidewall, and an outlet sidewall opposite said inlet first ramp inlet sidewall, said first ramp having a variable height and defining a first fluid channel transversely spanning said first ramp width and a first restrictor bar channel transversely spanning said first ramp width;
an inlet port, extending from and statically positioned on said first ramp inlet sidewall directly adjacent to said first fluid channel, with a inlet port primary aperture adapted to receive a hose end, a secondary inlet aperture, and an interior dispensing unit for the regulated passage of fluid from said secondary inlet aperture;
a secondary liquid container, removably affixed to said secondary inlet aperture;
a second ramp with a width, an inlet sidewall, and an outlet sidewall opposite said inlet first ramp inlet sidewall, said second ramp having a variable height and defining a second fluid channel transversely spanning said second ramp width and defining a second restrictor bar channel transversely spanning said second ramp width;
a perforated, pliable fluid conduit, affixed to said first ramp and extending unnaffixed from said first ramp outlet sidewall through second fluid channel from said second ramp inlet sidewall to and beyond said second ramp outlet sidewall, in fluid communication with said inlet port, wherein said fluid conduit is flexible to permit wrapping of said fluid conduit upon itself, and wherein said fluid conduit and said second fluid channel form a close-fit relation that permits said second fluid channel to statically maintain an predetermined orientation of said fluid conduit;
a restriction bar, removably spanning a wheelbase distance between said first ramp and said second ramp, contacting both said first ramp and second ramp to promote a stationary positioning on a substantially planar surface, wherein said restriction bar is size adjustable to permit user-determinable, parallel spacing of said first ramp to said second ramp;
a mating fastening complex positioned on said first ramp outlet sidewall and said second ramp inlet sidewall; and
a conduit restriction member, positioned on at least one of said second ramp and said fluid conduit, adapted to restrict fluid flow through said fluid conduit.

12. The device of claim 11 wherein said restriction bar includes a telescoping body.

13. The device of claim 12 further comprising restrictor clips, adapted to removably adhere via pressure mount to said restrictor bar, and wherein said restriction bar includes a substantially flat profile.

14. The device of claim 13 wherein said restrictor bar includes peripheral clip notches adapted to position said restrictor clips thereon.

15. The device of claim 11 further comprising a restrainer, positioned on said second ramp, dimensioned to retain and collapse said fluid conduit.

16. The device of claim 11 further comprising wind clips, protruding from both said first ramp inlet sidewall and said second ramp outlet sidewall.

17. A portable vehicle undercarriage washing device comprising:
a first ramp with a width, an inlet sidewall, and an outlet sidewall opposite said inlet first ramp inlet sidewall, said first ramp having a variable height and defining a first fluid channel transversely spanning said first ramp width and a first restrictor bar channel transversely spanning said first ramp width;
a inlet port, statically positioned on said first ramp inlet sidewall directly adjacent to said first fluid channel, with an inlet aperture adapted to receive a hose end;
a second ramp with a width, an inlet sidewall, and an outlet sidewall opposite said inlet first ramp inlet sidewall, said second ramp having a variable height and defining a second fluid channel transversely spanning said second ramp width and defining a second restrictor bar channel transversely spanning said second ramp width;
a perforated, pliable fluid conduit, affixed to said first ramp and extending unnaffixed from said first ramp outlet sidewall through second fluid channel from said second ramp inlet sidewall to and beyond said second ramp outlet sidewall, in fluid communication with said inlet port, wherein said fluid conduit is flexible to permit wrapping of said fluid conduit upon itself, and wherein said fluid conduit and said second fluid channel form a close-fit relation that permits said second fluid channel to statically maintain an predetermined orientation of said fluid conduit;
a removable restriction bar, removably spanning a wheelbase distance between said first ramp and said second ramp and through both said second restrictor bar channel and said first restrictor bar channel, contacting both said first ramp and second ramp to promote a stationary positioning on a substantially planar surface, wherein said restriction bar is size adjustable to permit user-determinable, parallel spacing of said first ramp to said second ramp;
a mating fastening complex positioned on said first ramp outlet sidewall and said second ramp inlet sidewall; and
a conduit restriction member, positioned on at least one of said second ramp and said fluid conduit, adapted to restrict fluid flow through said fluid conduit.

18. The device of claim 17 further comprising a secondary inlet aperture in fluid communication with said inlet port.

19. The device of claim 18 wherein said inlet port protrudes from said first ramp and includes an interior dispensing unit for the regulated passage of fluid from said secondary inlet aperture.

20. The device of claim 19 further comprising a secondary liquid container, removably affixed to said secondary inlet aperture, and wherein said secondary inlet aperture is positioned on said inlet port.
